(19) United States
(12) Patent Application Publication
(10) Pub. No.: US 2010/0155517 A1
(43) Pub. Date: Jun. 24, 2010

(54) MULTIPLE CHAMBER CONDIMENT GRINDER

(76) Inventor: TOM TAO WEN, San Marin, CA (US)

Correspondence Address: William H. Dippert;Eckert Seamans Cherin & Mellott, LLC, U.S. Steel Tower, 600 Grant Street, 44th Floor, Pittsburgh, PA, 15219, US

(21) Appl. No.: 12/636,842

(22) Filed: Dec. 14, 2009

(30) Foreign Application Priority Data
Dec. 22, 2008 (CN) 200820157531 1
Jan. 16, 2009 (CN) 200930093349 4

(51) Int. Cl. A47J 42/00; B65D 25/04

(52) U.S. Cl. 241/169.1; 220/553

(57) ABSTRACT

A condiment grinder comprises a housing with at least two separate chambers, each configured to hold one of the condiments. A separate grinder is mounted on a side of the housing adjacent each chamber for grinding and dispensing the condiment from the respective chamber. The grinders each have a rotational axis which intersects the axis of the other grinders at the approximate center of the housing. A separate hand crank, operative to rotate each grinder about its axis, is disposed on the opposite side of the housing from the respective grinder to which it is connected.

### BACKGROUND OF THE INVENTION

The present invention relates to a hand-held condiment grinder that includes multiple chambers for storing condiments and an equal number of grinding mechanisms, one for each chamber, for grinding and dispensing the stored condiments.

Hand-held condiment grinders are well known. These grinders usually have a single chamber for holding only one condiment at a time, such as peppercorns, rock salt, spices and the like.

Some grinders have more than one chamber and grinding mechanisms for storing, grinding and dispensing two or more different condiments. The convenience of having two or more condiments readily available to the user is an ergonomic and time-saving benefit but these multiple condiment grinders require significantly more space for the grinding mechanisms.

The size and shape of a hand-held condiment grinder is of significant importance, since a hand-held device must be small enough to allow for one hand to grasp the grinder while the other operates the grinding mechanism.

### SUMMARY OF THE INVENTION

A principal object of the present invention is to provide a condiment grinder for storing, grinding and dispensing at least two different condiments.

A further object of the present invention is to provide a condiment grinder of the aforementioned type which is light and convenient to hold in one hand, so that the opposite hand may be used to operate the grinding mechanism.

These objects, as well as further objects which will become apparent from the discussion that follows, are achieved, in accordance with the present invention, by providing a condiment grinder of the type described above which comprises a housing with at least two separate chambers, each configured to hold one of the condiments. A separate grinder is mounted on a side of the housing adjacent each chamber for grinding and dispensing the condiment from the respective chamber. The grinders each have a rotational axis which intersects the axis of the other grinders at the approximate center of the housing. A separate hand crank, operative to rotate each grinder about its axis, is disposed on the opposite side of the housing from the respective grinder to which it is connected.

### BRIEF DESCRIPTION OF THE DRAWINGS

FIG. 1 is a perspective view of the preferred embodiment of the condiment grinder according to the present invention.

FIG. 2 is a plan view showing six sides of the condiment grinder of FIG. 1 with the cranks in their closed, foldaway positions, flush with the housing.

FIG. 3 is a plan view showing the six sides of the condiment grinder of FIG. 1 with the cranks in their open, operative positions.

FIG. 4 is an assembly diagram showing the various components of the condiment grinder of FIG. 1.

### DESCRIPTION OF THE PREFERRED EMBODIMENT

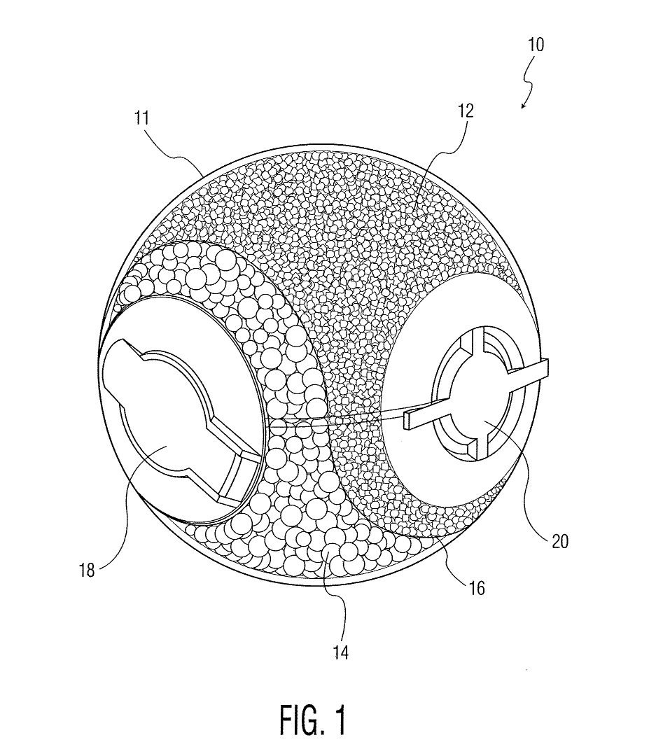

The preferred embodiment of the present invention will now be described with reference to FIGS. 1-4 of the drawings Identical elements in the various figures are identified with the same reference numerals.

FIG. 1 shows a condiment grinder 10 of generally spherical shape formed of a clear plastic housing 11 with condiment chambers 12 and 14 arranged therein. The dividing wall between the chambers meets the outer wall of the housing along a line that forms the same pattern as the seam of a tennis ball. If one of the condiments is white rock salt, as shown in the chamber 12, and the other condiment is black peppercorns, as shown in chamber 14, the resulting appearance is similar to that of the Asian symbol “Ying Yang.”

The rock salt in the chamber 12 is ground and dispensed through a grinder 20a on one side of the housing (hidden from view) which is operated by a crank 18a. The peppercorns are ground and dispensed by a grinder 20b which is operated by a hand crank 18b on the opposite side of the housing (hidden from view).

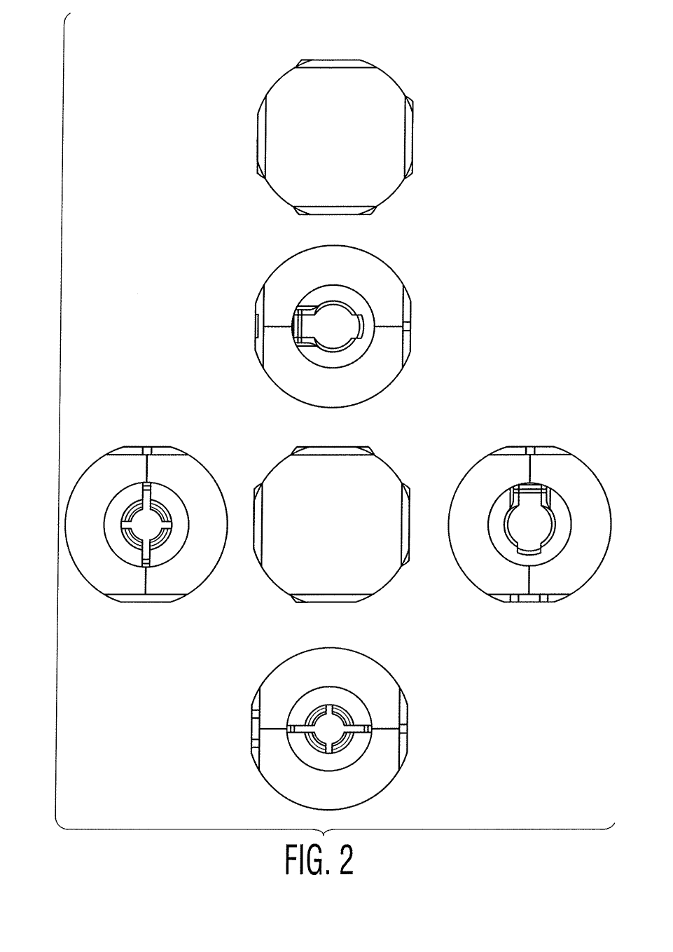

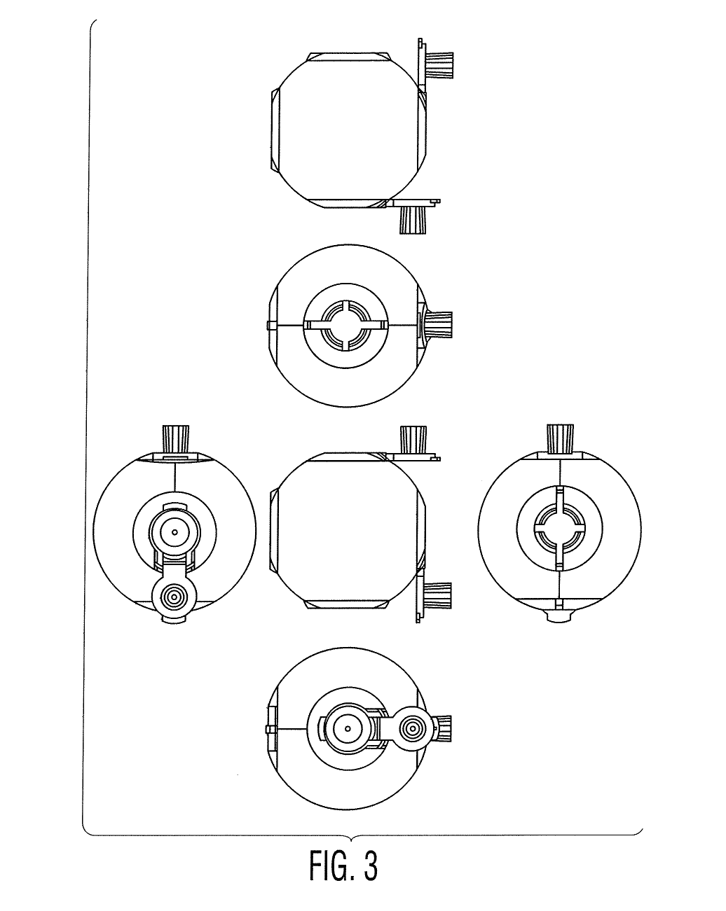

FIGS. 2 and 3 show the six sides of the condiment grinder with the cranks 18 folded inward for storage (FIG. 2) and folded outward for operation (FIG. 3). As is best seen in FIG. 3, a crank disposed on one side of the housing operates to rotate an associated grinder on the opposite side of the housing. The crank and its associated grinder rotate about a common axis 21a, 21b which passes through the approximate center of the housing.

In this preferred embodiment, the axis of the two grinders intersect at an angle of 90 degrees; however, it will be understood that in a condiment grinder with more than two chambers, the axis may intersect with an angle less than 90 degrees—45 degrees, for example. It will also be understood that the housing 11 of the condiment grinder 10 may assume other shapes, such as a polygonal shape or that of a cube.

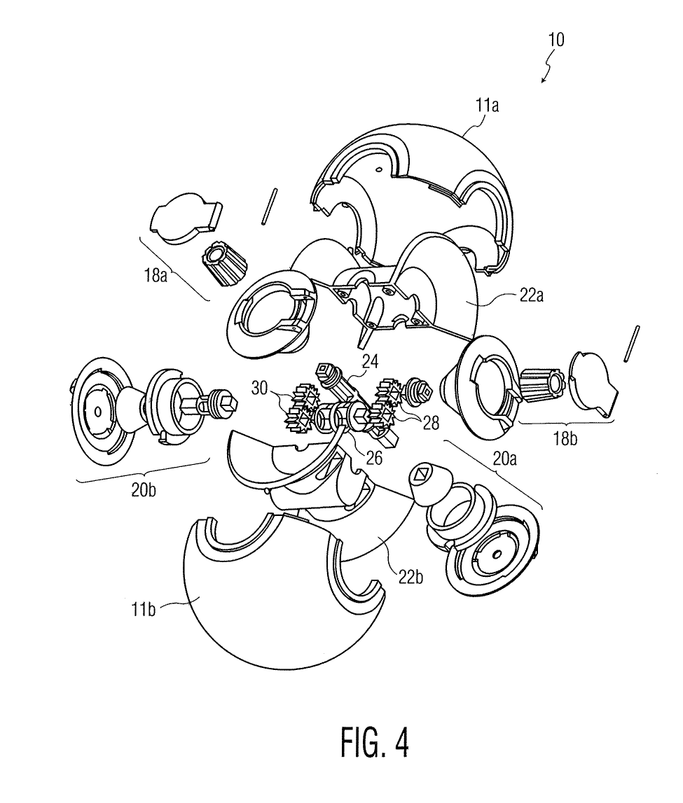

FIG. 4 is an exploded view showing the various parts of the grinder. As shown, the housing 11 is formed of two semispherical halves 11A and 11B and the chambers are formed by dividing wall sections 22A and 22B.

The cranks 18a and 18b, each formed by a hinge with a knob, are attached to their respective grinders 20a and 20b. The crank 18a is directly connected to the grinder 20b by a straight rod 24 disposed along the rotational axis of the grinder 20a. The crank 18b is attached to the grinder 20b via a by-pass mechanism which includes a by-pass rod 26 disposed parallel to, but offset from, the rotational axis of the grinder 20b. A mechanical transfer mechanism, which includes gears 28 and 30 connects the crank 18b on one side, and grinder 20b, on the other, to the by-pass rod 26 for rotation therewith.

The transfer gears 28 and 30 preferably provide a one-to-one gear ratio so that the grinder 20b rotates at the same speed as the crank 18b; however, other gear ratios may be used instead.

There has thus been shown and described a novel multiple chamber condiment grinder which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A condiment grinder for storing, grinding and dispensing at least two different condiments, said grinder comprising, in combination:
(a) a housing having a first chamber configured to hold a first condiment and a second chamber to hold a second condiment;
(b) a first grinder disposed on a side of the housing adjacent the first chamber for grinding and dispensing the first condiment, said first grinder having a first rotational grinding axis;
(c) a second grinder disposed on a side of the housing adjacent the second chamber for grinding and dispensing the second condiment, the second grinder having a second rotational grinding axis that intersects the first axis at a location within the housing at a prescribed angle.

2. The condiment grinder defined in claim 1, wherein said housing is substantially spherical in shape.

3. The condiment grinder defined in claim 1, wherein said housing is substantially cubical in shape.

4. The condiment grinder defined in claim 1, wherein said housing is substantially polygonal in shape.

5. The condiment grinder defined in claim 1, further comprising a first crank for manually rotating said first grinder about the first axis and a second crank for manually rotating the second grinder about the second axis.

6. The condiment grinder defined in claim 5, wherein the first and second cranks are each hinged for movement between an open, operative position and a closed position embedded in the housing.

7. The condiment grinder defined in claim 5, wherein the first and second cranks are each disposed on an opposite side of the housing from the first and second grinders, respectively.

8. The condiment grinder defined in claim 7, wherein said first grinder and said first crank are both arranged for rotation about said first grinder axis, wherein said second grinder and said second crank are both arranged for rotation about said second grinder axis, and wherein said grinder further comprises a mechanical device connecting each one of said first and second cranks to a respective one of said first and second grinders.

9. The condiment grinder defined in claim 8, wherein said mechanical device includes a first straight rod disposed along said first axis directly connecting said first crank to the first grinder for common rotation, and a bypass mechanism connecting second crank to said second grinder without intersecting said first rod.

10. The condiment grinder defined in claim 9, wherein said bypass mechanism includes a bypass rod disposed parallel to, but offset from, said second axis, and a mechanical transfer mechanism connecting second crank and said second grinder, respectively, to said bypass rod for rotation therewith.

11. The condiment grinder defined in claim 10, wherein the mechanical transfer mechanism is operative to rotate said second grinder at the same speed as said second crank.

12. The condiment grinder defined in claim 1, wherein there are two condiment chambers in said housing, and wherein said prescribed angle is 90 degrees.
